(19) United States
(12) Patent Application Publication
(10) Pub. No.: US 2007/0112169 A1
(43) Pub. Date: May 17, 2007

(54) Sulfonated polyaryletherketones

(75) Inventors: Daniel Joseph Brunelle, Burnt Hills, NY (US); Hongyi Zhou, Niskayuna, NY (US); Hongwei Liu, Troy, NY (US); Marianne Elisabeth Harmon, Niskayuna, NY (US); David Roger Moore, Albany, NY (US); Joyce Hung, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/272,312

(22) Filed: Nov. 14, 2005

(51) Int. Cl. C08G 16/00

(52) U.S. Cl. 528/220

(57) ABSTRACT

Processes for controlled sulfonation of a polyaryletherketone comprise reacting a monomer of formula VIII with a monomer of formula IX to form a polyaryletherketone; and sulfonating the polyaryletherketone to form a sulfonated polyaryletherketone comprising structural units of formula IV 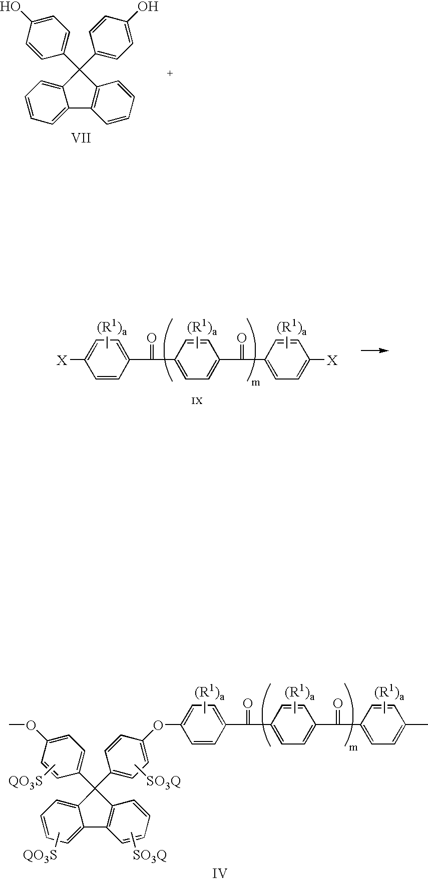
wherein R¹ is halogen, C₁-C₁₀ alkyl, C₃-C₁₂ cycloalkyl, or C₃-C₁₅ aryl; a is an integer from 0 to 4; Y is F, Cl, Br or a mixture thereof; m is 0 or 1; and Q is H, a metal cation, a non-metallic inorganic cation, an organic cation or a mixture thereof.

### BACKGROUND

The invention relates generally to sulfonated polyaryletherketones for use as proton exchange membranes.

Solid polymer electrolyte membrane (PEM) fuel cells have attracted much attention recently due to their potential application as a clean source of energy, in particular for transportation, and portable devices. Nafion® is by far the most widely used membrane in PEM fuel cells because of its chemical and mechanical stability, high proton conductivity, and long durability under fuel cell conditions. However, low operation temperature and high cost of these membranes have limited their practical, large-scale application in PEM fuel cells. Consequently, much effort has been made to develop alternative low-cost membrane materials for PEM fuel cells.

Sulfonated polyaryletherketones (SPAEKs) have been extensively studied as proton exchange membrane for fuel cell applications due to their high conductivity, good long-term chemical and mechanical properties and low-cost. Polyarylether ketones (PAEKs) have a backbone comprising aromatic rings linked by ether and ketone groups. The polymers are typically synthesized by the polymerization reaction of stoichiometric amounts of one or more bisphenol compounds, such as bisphenols or bisphenolate salts, with a dihalobenzophenone. Sulfonic acid groups can be attached to the polymer backbone either by postsulfonation of polymer or by direct copolymerization of sulfonated monomers. Postsulfonation is an easy, widely used approach to produce sulfonated PAEKs, but it is lacks precise control over the degree and location of sulfonation.

Sakaguchi et al. disclose polyaryletherketones containing disulfonated diphenylfluorenylidene groups, and polyethersulfones containing tetrasulfonated diphenylfluorenylidene groups (Polymer Preprints, 45, 20 (2004)). The authors were unable to prepare the desired tetrasulfonated polyaryletherketones that also included perfluorinated units.

Therefore, there remains a need for polyaryletherketones containing perfluorinated groups and the well-defined sulfonated domains obtainable with residues of 4,4′-(9-fluorenylidene)diphenol (FDP).

### BRIEF DESCRIPTION

It has been unexpectedly discovered that sulfonation of polyaryletherketones containing units derived from FDP results in a polymer having sulfonyl groups located exclusively on the four rings of the diphenyl fluorenylidene moieties. These sulfonated polyaryletherketones exhibit high proton conductivity (0.21 S/cm at 80° C., 100% relative humidity) and have glass transition temperatures significantly higher than NAFION®.

Accordingly, in one embodiment, the present invention relates to sulfonated polyaryletherketones comprising structural units of formula I 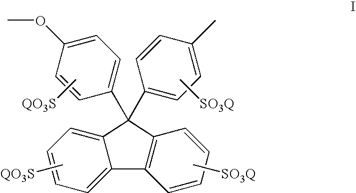
wherein Q is H, a metal cation, a non-metallic inorganic cation, an organic cation or a mixture thereof.
The sulfonated polyaryletherketones may additionally include structural units of formula II and/or III 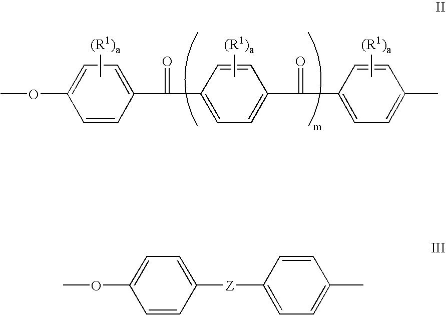
wherein R¹ is halogen, C₁-C₁₀ alkyl, C₃-C₁₂ cycloalkyl, or C₃-C₁₅ aryl;
   a is an integer from 0 to 4; and
   m is 0 or 1.
   Z is a direct bond or O, S, (CH₂)_{y}, (CF₂)_{y}, C(CH₃)₂, C(CF₃)₂, or a combination thereof; and
   y is an integer from 1 to 5.

In another embodiment, the present invention relates to processes for controlled sulfonation of a polyaryletherketone. The process comprises reacting a monomer of formula VIII with a monomer of formula IX to form a polyaryletherketone; and 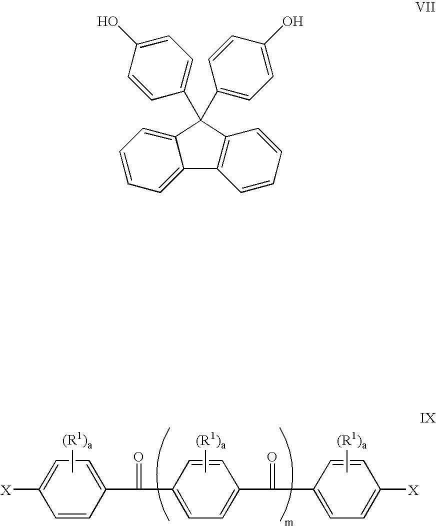
sulfonating the polyaryletherketone to form a sulfonated polyaryletherketone comprising structural units of formula IV 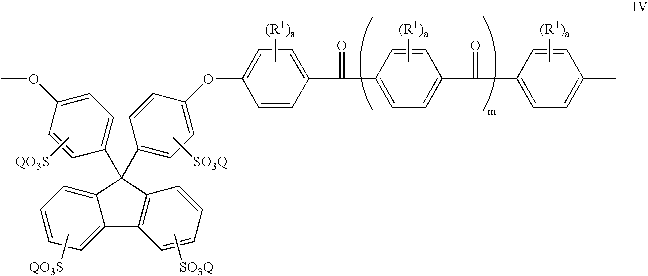
wherein R¹ is halogen, C₁-C₁₀ alkyl, C₃-C₁₂ cycloalkyl, or C₃-C₁₅ aryl;
   a is an integer from 0 to 4;
   Y is F, Cl, Br or a mixture thereof;
   m is 0 or 1; and
   Q is H, a metal cation, a non-metallic inorganic cation, an organic cation or a mixture thereof.
      The monomers of formulae VIII and IX may additionally be reacted with a monomer of formula X 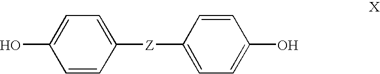
      wherein Z is a direct bond or O, S, (CH₂)_{y}, (CF₂)_{y}, C(CH₃)₂, C(CF₃)₂, or a combination thereof; and y is an integer from 1 to 5.

In other embodiments, the present invention relates to proton exchange membranes comprising sulfonated polyaryletherketones according to the present invention, and fuel cells containing them.

### DETAILED DESCRIPTION

In one embodiment, the present invention relates to sulfonated polyarylether ketone comprising structural units of formula I 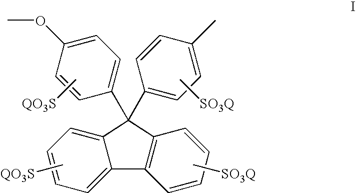
wherein Q is H, a metal cation, a non-metallic inorganic cation, an organic cation or a mixture thereof. In separate embodiments, the present invention also relates to proton exchange membranes that include the sulfonated polyaryletherketones, and to fuel cells that include the proton exchange membranes.

The units of formula I may be formed by treating the polyaryletherketone with a sulfonating agent after formation of the polymer (postsulfonation). Examples of suitable sulfonating agents include SO₃, ClSO₃H, Me₃SiSO₃Cl, and fuming or concentrated H₂SO₄. If desired, the units of formula I may be formed by sulfonating a monomer containing the diphenylfluorenylidene group, usually a di(hydroxyphenyl)-9-fluorenylidene compound, prior to polymerization (presulfonation). However, postsulfonation is typically more convenient and less costly.

Sulfonated polyaryletherketones according to various embodiments of the present invention may include structural units of formula II in addition to those of formula I 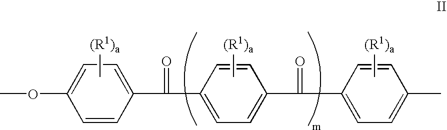
wherein R¹ is halogen, C₁-C₁₀alkyl, C₃-C₁₂ cycloalkyl, or C₃-C₁₅ aryl;
a is an integer from 0 to 4; and
m is 0 or 1.

The units of formula II may be derived from one or more substituted or unsubstituted dihalobenzophenone such as 4-fluorobenzophenone or 4-chlorobenzophenone, or from a di(halobenzoyl)benzene such as 1,4-bis-(4-fluorobenzoyl)benzene or 1,4-bis-(4-chlorobenzoyl)benzene. In a particular embodiment, a and m are 0, and the units of formula II are derived from an unsubstituted dihalobenzophenone.

The sulfonated polyaryletherketones may also include structural units of formula III in addition to those of formula I 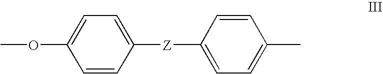
wherein Z is a direct bond or O, S, CO, (CH₂)_{y}, (CF₂)_{y}, C(CH₃)₂, C(CF₃)₂, or a combination thereof; and y is an integer from 1 to 5.

The units of formula III may be derived from one or more dihydroxyaryl monomers, particularly bisphenol monomers. Examples of suitable dihydroxyaryl monomers include bisphenol A, 6F-bisphenol, 4,4′-biphenol, hydroquinone and phenylphosphine oxide bisphenol. Aryl groups of any of the monomers may be substituted with halogen groups, such as bromo, chloro, fluoro; alkyl groups, particularly C₁-C₈ alkyl; allyl groups, alkenyl groups, ether groups, alkyl ether groups, and cyano groups. (It should be noted that substitution with chloro and/or fluoro groups may lead to branching and crosslinking of the sulfonated polyaryletherketone.) The bisphenol monomers may be either symmetrical or unsymmetrical. In a particular embodiment, Z is C(CF₃)₂, and the units of formula III are derived from a (hydroxyphenyl)hexafluoroisopropylidene monomer, for example, 2,2-bis-(4-hydroxy-phenyl)-1,1,1,3,3,3-hexafluoropropane.

Other dihydroxyaryl monomers that may be used to prepare the sulfonated polyaryletherketones include 1,1-bis-(4-hydroxyphenyl)cyclopentane; 2,2-3-allyl-4-hydroxyphenyl)propane; 2,2-bis-(2-t-butyl-4-hydroxy-5-methylphenyl)propane; 2,2-bis-(3-t-butyl-4-hydroxy-6-methylphenyl)propane; 2,2-bis-(3-t-butyl-4-hydroxy-6-methylphenyl)butane; 2,2-bis-(3-methyl-4-hydroxyphenyl)propane; 1,1-4-hydroxy-phenyl)-2,2,2-trichloroethane; 1,1-bis-(4-hydroxyphenyl)norbornane; 1,2-4-hydroxy-phenyl)ethane; 1,3-bis-(4-hydroxyphenyl)propenone; 4-hydroxyphenyl)sulfide; 4,4-bis-(4-hydroxyphenyl)pentanoic acid; 4,4-3,5-dimethyl-4-hydroxyphenyl)pentanoic acid; 2,2-bis-(4-hydroxyphenyl)acetic acid; 2,4′-dihydroxydiphenyl-methane; bis-(2-hydroxyphenyl)methane; bis-(4-hydroxy-phenyl)methane; bis-(4-hydroxy-5-nitrophenyl)methane; bis-(4-hydroxy-2,6-dimethyl-3-methoxyphenyl)methane; 1,1-bis-(4-hydroxyphenyl) ethane; 1,1-4-hydroxy-2-chlorophenyl)ethane; 2,2-bis-(4-hydroxyphenyl)propane (bisphenol-A); 1,1-bis-(4-hydroxyphenyl)propane; 2,2-bis-(3-chloro-4-hydroxyphenyl)propane; 2,2-bis-(3-bromo-4-hydroxyphenyl)propane; 2,2-bis-(4-hydroxy-3-methylphenyl)propane; 2,2-bis-(4-hydroxy-3-isopropylphenyl) propane; 2,2-bis-(3-t-butyl-4-hydroxyphenyl)propane; 2,2-bis-(3-phenyl-4-hydroxy-phenyl)propane; 2,2-3,5-dichloro-4-hydroxyphenyl)propane; 2,2-bis-(3,5-dibromo-4-hydroxyphenyl)propane; 2,2-bis-(3,5-dimethyl-4-hydroxy-phenyl)propane; 2,2-bis-(3-chloro-4-hydroxy-5-methylphenyl)propane; 2,2-bis-(3-bromo-4-hydroxy-5-methylphenyl)propane; 2,2-bis-(3-chloro-4-hydroxy-5-isopropylphenyl)propane; 2,2-bis-(3-bromo-4-hydroxy-5-isopropylphenyl) propane; 2,2-bis-(3-t-butyl-5-chloro-4-hydroxyphenyl)propane; 2,2-bis-(3-bromo-5-t-butyl-4-hydroxyphenyl)propane; 2,2-bis-(3-chloro-5-phenyl-4-hydroxyphenyl)propane; 2,2-bis-(3-bromo-5-phenyl-4-hydroxyphenyl)propane; 2,2-bis-(3,5-disopropyl-4-hydroxyphenyl) propane; 2,2-bis-(3,5-di-t-butyl-4-hydroxyphenyl) propane; 2,2-bis-(3,5-diphenyl-4-hydroxyphenyl)propane; 2,2-bis-(4-hydroxy-2,3,5,6-tetrachlorophenyl)propane; 2,2-bis-(4-hydroxy-2,3,5,6-tetrabromophenyl)propane; 2,2-bis-(4-hydroxy-2,3,5,6-tetramethylphenyl)propane; 2,2-bis-(2,6-dichloro-3,5-dimethyl-4-hydroxyphenyl)propane; 2,2-bis-(2,6-dibromo-3,5-dimethyl-4-hydroxyphenyl)propane; 2,2-bis-(4-hydroxy-3-ethylphenyl)propane; 2,2-bis-(4-hydroxy-3,5-dimethylphenyl)propane; 2,2-bis-(3,5,3′,5′-tetrachloro-4,4′-dihydroxyphenyl)-propane; 1,1-bis-(4-hydroxyphenyl)cyclohexylmethane; 2,2-bis-(4-hydroxyphenyl)-1-phenylpropane; 1,1-bis-(4-hydroxyphenyl)cyclohexane; 1,1-bis-(3-chloro-4-hydroxyphenyl)cyclohexane; 1,1-bis-(3-bromo-4-hydroxyphenyl)cyclohexane; 1,1-bis-(4-hydroxy-3-methylphenyl)cyclohexane; 1,1-bis-(4-hydroxy-3-isopropylphenyl)cyclohexane; 1,1-bis-(3-t-butyl-4-hydroxyphenyl)cyclohexane; 1,1-bis-(3-phenyl-4-hydroxy-phenyl)cyclohexane; 1,1-bis-(3,5-dichloro-4-hydroxyphenyl)cyclohexane; 1,1-bis-(3,5-dibromo-4-hydroxyphenyl)cyclohexane; 1,1-bis-(3,5-dimethyl-4-hydroxy-phenyl)cyclohexane; 1,1-bis-(3-chloro-4-hydroxy-5-methylphenyl)cyclohexane; 1,1-bis-(3-bromo-4-hydroxy-5-methylphenyl)cyclohexane; 1,1-bis-(3-chloro-4-hydroxy-5-isopropylphenyl)cyclohexane; 1,1-bis-(3-bromo-hydroxy-5-isopropylphenyl)cyclohexane; 1,1-bis-(3-t-butyl-5-chloro-4-hydroxyphenyl)cyclohexane; 1,1-bis-(3-bromo-5-t-butyl-4-hydroxyphenyl)cyclohexane; 1,1-bis-(3-chloro-5-phenyl-4-hydroxyphenyl)cyclohexane; 1,1-bis-(3-bromo-5-phenyl-4-hydroxyphenyl)cyclohexane; 1,1-bis-(3,5-disopropyl-4-hydroxyphenyl)cyclohexane; 1,1-bis-(3,5-di-t-butyl-4-hydroxyphenyl)cyclohexane; 1,1-bis-(3,5-diphenyl-4-hydroxyphenyl)cyclohexane; 1,1-bis-(4-hydroxy-2,3,5,6-tetrachlorophenyl)cyclohexane; 1,1-bis-(4-hydroxy-2,3,5,6-tetrabromophenyl)cyclohexane; 1,1-bis-(4-hydroxy-2,3,5,6-tetramethylphenyl)cyclohexane; 1,1-bis-(2,6-dichloro-3,5-dimethyl-4-hydroxyphenyl)cyclohexane; 1,1-bis-(2,6-dibromo-3,5-dimethyl-4-hydroxyphenyl)cyclohexane; 1,1-bis-(4-hydroxyphenyl)-3,3,5-trimethylcyclohexane; 1,1-bis-(3-chloro-4-hydroxyphenyl)-3,3,5-trimethylcyclohexane; 1,1-bis-(3-bromo-4-hydroxyphenyl)-3,3,5-trimethylcyclohexane; 1,1-bis-(4-hydroxy-3-methylphenyl)-3,3,5-trimethylcyclohexane; 1,1-bis-(4-hydroxy-3-isopropylphenyl)-3,3,5-trimethylcyclohexane; 1,1-bis-(3-t-butyl-4-hydroxyphenyl)-3,3,5-trimethylcyclohexane; 1,1-bis-(3-phenyl-4-hydroxyphenyl)-3,3,5-trimethylcyclohexane; 1,1-bis-(3,5-dichloro-4-hydroxyphenyl)-3,3,5-trimethylcyclohexane; 1,1-bis-(3,5-dibromo-4-hydroxyphenyl)-3,3,5-trimethylcyclohexane; 1,1-bis-(3,5-dimethyl-4-hydroxyphenyl)-3,3,5-trimethylcyclohexane; 1,1-bis-(3-chloro-4-hydroxy-5-methylphenyl)-3,3,5-trimethylcyclohexane; 1,1-bis-(3-bromo-4-hydroxy-5-methylphenyl)-3,3,5-trimethylcyclohexane; 1,1-bis-(3-chloro-4-hydroxy-5-isopropylphenyl)-3,3,5-trimethylcyclohexane; 1,1-bis-(3-bromo-4-hydroxy-5-isopropylphenyl)-3,3,5-trimethylcyclohexane; 1,1-bis-(3-t-butyl-5-chloro-4-hydroxyphenyl)-3,3,5-trimethylcyclohexane; 1,1-bis-(3-bromo-5-t-butyl-4-hydroxyphenyl)-3,3,5-trimethylcyclohexane; bis-(3-chloro-5-phenyl-4-hydroxyphenyl)-3,3,5-trimethylcyclohexane; 1,1-bis-(3-bromo-5-phenyl-4-hydroxyphenyl)-3,3,5-trimethylcyclohexane; 1,1-bis-(3,5-disopropyl-4-hydroxyphenyl)-3,3,5-trimethylcyclohexane; 1,1-bis-(3,5-di-t-butyl-4-hydroxyphenyl)-3,3,5-trimethylcyclohexane; 1,1-bis-(3,5-diphenyl-4-hydroxyphenyl)-3,3,5-trimethylcyclohexane; 1,1-bis-(4-hydroxy-2,3,5,6-tetrachlorophenyl)-3,3,5-trimethylcyclohexane; 1,1-bis-(4-hydroxy-2,3,5,6-tetrabromophenyl)-3,3,5-trimethylcyclohexane; 1,1-bis-(4-hydroxy-2,3,5,6-tetramethylphenyl)-3,3,5-trimethylcyclohexane; 1,1-bis-(2,6-dichloro-3,5-dimethyl-4-hydroxyphenyl)-3,3,5-trimethylcyclohexane; 1,1-bis-(2,6-dibromo-3,5-dimethyl-4-hydroxyphenyl)-3,3,5-trimethylcyclohexane; 4,4-bis-(4-hydroxyphenyl)heptane; 1,1-bis-(4-hydroxyphenyl)decane; 1,1-bis-(4-hydroxyphenyl)cyclododecane; 1,1-bis-(3,5-dimethyl-4-hydroxyphenyl)cyclododecane; and bis-(4-hydroxyphenyl)methane.

In another embodiment, the sulfonated polyaryletherketones comprise structural units of formula IV: 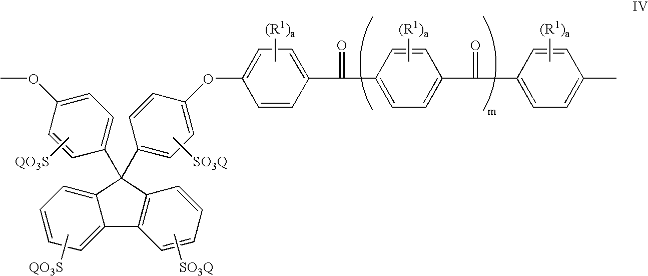
wherein R¹ is halogen, C₁-C₁₀ alkyl, C₃-C₁₂ cycloalkyl, or C₃-C₁₅ aryl;
   a is an integer from 0 to 4; and
   m is 0 or 1.
      In particular, a and m may be 0. The sulfonated polyaryletherketones may additionally comprise structural units of formula V: 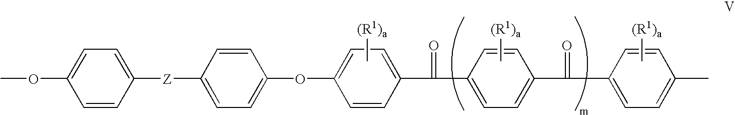
      wherein R¹ is halogen, C₁-C₁₀ alkyl, C₃-C₁₂ cycloalkyl, or C₃-C₁₅ aryl;
a is an integer from 0 to 4; and
m is 0 or 1.
   In particular embodiments, a and m may be 0, or Z may be C(CF₃)₂.
   In yet another embodiment, the sulfonated polyaryletherketones comprises structural units of formula VI and VII: 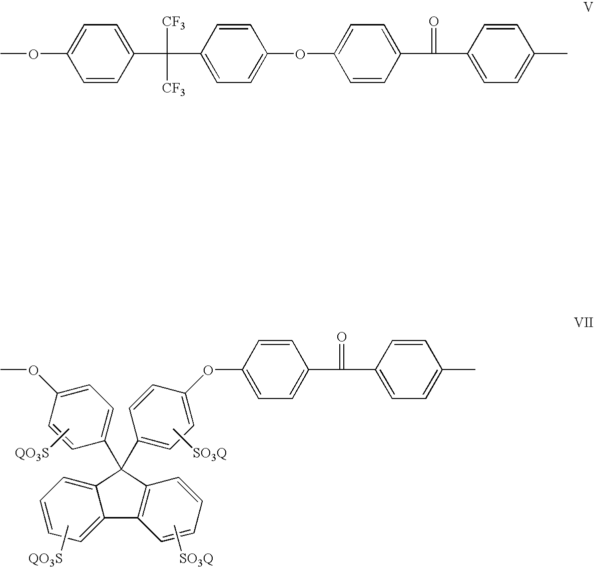
   wherein Q is Q is H, a metal cation, a non-metallic inorganic cation, an organic cation or a mixture thereof; and n is 20-50.

Molecular weight of the sulfonated polyaryletherketones is not critical. Weight average molecular weight (Mw) typically ranges from about 2,000 to about 100,000 Daltons, and particularly from about 10,000 to about 70,000 Daltons as measured by gel permeation chromatography using a polystyrene standard.

In another embodiment, the present invention relates to processes for controlled sulfonation of a polyaryletherketone. Such processes comprise reacting a monomer of formula VIII with a monomer of formula IX to form a polyaryletherketone; and 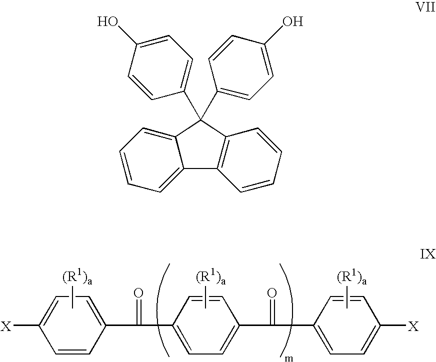
sulfonating the polyaryletherketone to form a sulfonated polyaryletherketone comprising structural units of formula IV 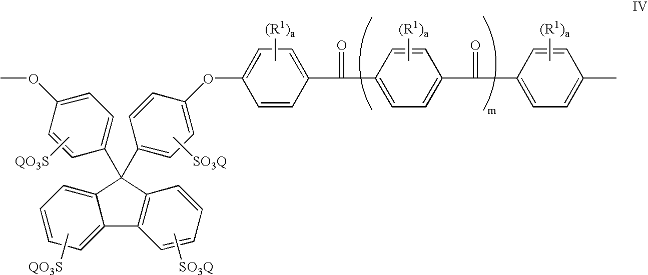
wherein R¹ is halogen, C₁-C₁₀ alkyl, C₃-C₁₂ cycloalkyl, or C₃-C₁₅ aryl;
a is an integer from 0 to 4;
X is F, Cl, Br or a mixture thereof;
m is 0 or 1; and
Q is Q is H, a metal cation, a non-metallic inorganic cation, an organic cation or a mixture thereof.
In particular, a and m may be 0.
In another embodiment, the processes may additionally comprise reacting the monomer of formula VIII and monomer of formula IX with a monomer of formula X 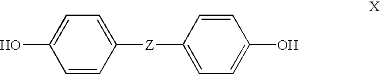
wherein Z is a direct bond or O, S, (CH₂)_{y}, (CF₂)_{y}, C(CH₃)₂, C(CF₃)₂, or a combination thereof, and y is an integer from 1 to 5.
In particular, Z may be C(CF₃)₂.

The bulky sulfonated diphenylfluorenylidene moiety may introduce nanoscale pores composed of sulfonated groups. Such nanoscale structure typically results in high water uptake of the polymer films, which also leads to high proton conductivity.

The polyaryletherketones may be formed by processes known in the art, which include Friedel-Crafts reaction of stoichiometric amounts of aromatic bisbenzoyl chlorides with arenes, nucleophilic displacement of stoichiometric quantities of bisphenolate salts with activated aromatic dihalides in polar aprotic solvents, and phase transfer catalyzed nucleophilic displacement of bisphenols with hexafluorobenzene. U.S. Pat. No. 4,882,397 to Kelsey, U.S. Pat. No. 4,419,486 to Rose, U.S. Pat. No. 4,186,262 to Freeman, and U.S. Pat. No. 5,288,834 to Roovers teach various processes for preparing or reacting polyaryletherketones. Kelsey teaches a process for preparing polyarylether ketones from a polyketal. Rose teaches sulfonation of polyarylether ketones. Freeman teaches preparation of mixed polyaryletherketone-polyethersulfones. Roovers et al. teach bromomethyl derivatives of polyarylether ketones are useful intermediates for further functionalizing the aromatic polyether ketones, and further teach functionalized polyarylether ketones such as carbonyl fluoride poly (aryl ether-ether ketone), cyan methylene poly(aryl ether ether ketone), diethylamine methylene poly(aryl ether ether ketone), and aldehyde polyaryl (aryl ether ether ketone).

For phase transfer catalyzed nucleophilic displacement reactions, suitable phase transfer catalysts include hexaalkylguanidinium salts, and bis-guanidinium salts. Typically the phase transfer catalyst comprises an anionic species such as mesylate, tosylate, tetrafluoroborate, acetate as the charge-balancing counterion(s). Suitable guanidinium salts include those disclosed in U.S. Pat. Nos. 5,132,423; 5,116,975; and 5,081,298. Other suitable phase transfer catalysts include p-dialkylaminopyridinium salts, bis-dialkylaminopyridinium salts, bis-quaternary ammonium salts, bis-quaternary phosphonium salts, and phosphazenium salts. Suitable bis-quaternary ammonium and phosphonium salts are disclosed in U.S. Pat. No. 4,554,357. Suitable aminopyridinium salts are disclosed in U.S. Pat. Nos. 4,460,778; 4,513,141 and 4,681,949. Suitable phosphazenium salts include those disclosed in U.S. patent application Ser. No. 10/950,874 paragraphs 25, 26, 27, 28, 29, and 30 of which are incorporated herein by reference. Additionally, in certain embodiments, quaternary ammonium and phosphonium salts as disclosed in U.S. Pat. No. 4,273,712 may also be used.

In particular, the polyaryletherketones may be synthesized by the polymerization reaction of stoichiometric amounts of 4,4′-(9-fluorenylidene)diphenol and one or more bisphenol compounds, such as bisphenols or bisphenolate salts, particularly those containing perfluorinated groups, with a dihalobenzophenone in a polar aprotic solvent, such as N,N-dimethylacetamide (DMAc), and an azeotroping solvent, such as toluene, under refluxing conditions. The reaction is generally catalyzed by a base, preferably an inorganic base such as potassium carbonate, potassium hydroxide or cesium fluoride. Generally two equivalents of the base are used with respect to the bisphenol.

### EXAMPLES

The polyaryletherketones were synthesized by potassium carbonate mediated direct aromatic nucleophilic substitution polycondensation of 4-fluorobenzophenone, 4,4′-(9-fluorenylidene)diphenol (FDP) and 4,4′-(hexafluoroisopropylidene) diphenol (6F-BPA). Scheme 1 illustrates the process. Copolymerization proceeded quantitatively to high molecular weight in DMAc at 155-165° C.

Sulfonated polyarylether ketones were prepared by sulfonation of polyaryletherketones using concentrated sulfuric acid at room temperature for the desired time. The number of sulfonated moieties was controlled by varying the mole ratio of staring monomers of 6F-BPA and FDP. Strong and flexible films were successfully cast from the solution of sulfonated polyaryletherketones in DMSO when FDP was 20-50% in polymer backbone.

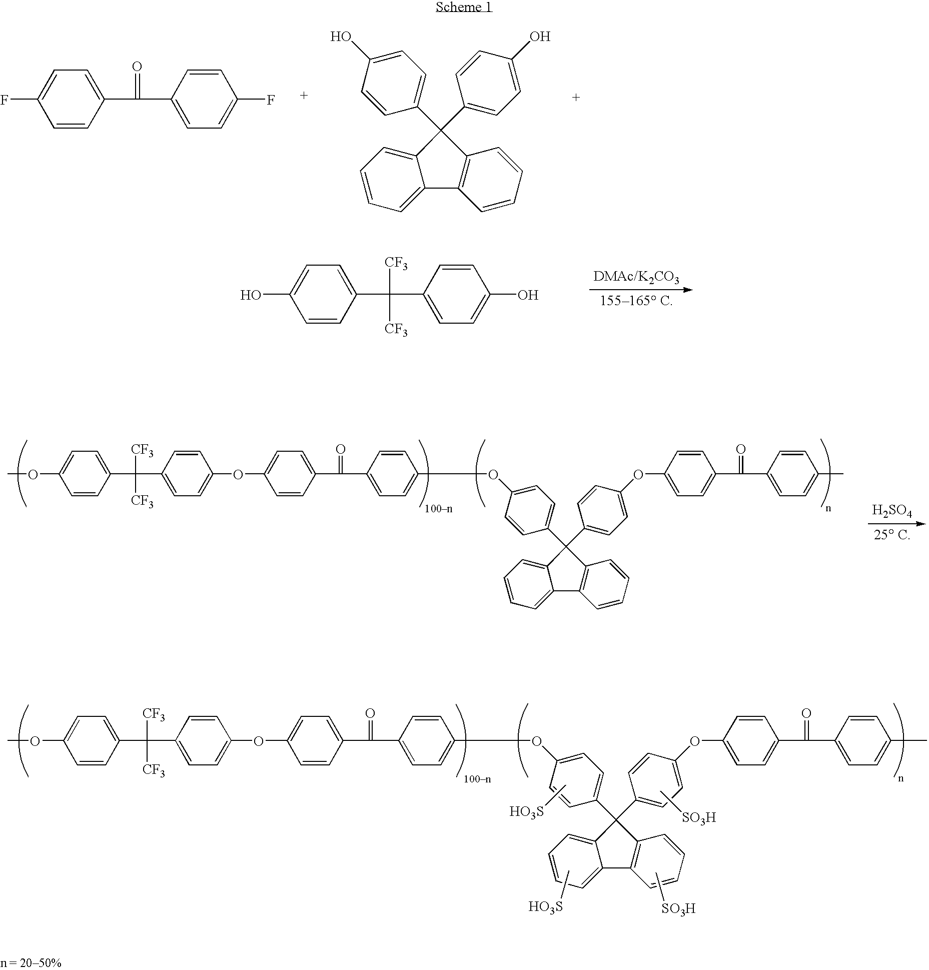

General experimental procedure: potassium carbonate was dried in oven at 140° C. before use, and all the other chemicals were used as received.

### Example 1

### Standard Procedure for Synthesis of the Polyaryletherketones

4,4′-Difluorobenzophenone (2.182 g, 10 mmol), 4,4′-(9-fluorenylidene)diphenol (1.0512 g, 3 mmol), 4,4′-(hexafluoroisopropylidene) diphenol (2.3536 g, 7 mmol), dry DMAc (30 ml) and potassium carbonate (1.94 g, 14 mmol) were added into a three neck round bottom flask equipped with a mechanical stirred and a nitrogen inlet. Toluene (20 ml) was used as an azeotropic agent. The reaction mixture was heated at 155° C. for 15 hours, and then at 165° C. for 5 hours. The polymer solution became viscous and was cooled to room temperature and diluted with DMAc. The polymer was precipitated using a blender in a mixture of water and methanol. The precipitated polymer was collected by filtration, and washed extensively with de-ionized water and ethanol to remove salt, finally dried in a vacuum oven overnight.

### Example 2

### Standard Procedure for Sulfonation of the Polyaryletherketones

Sulfonation was carried out by dissolving the above polyaryletherketone polymer (1.5 g) in concentrated sulfuric acid (20 ml), and stirring for the desired time at room temperature. After the reaction, the mixture was poured into ice water. The sulfonated polymer was collected by filtration, and washed with de-ionized water until the rinse water was at pH 6-7, and dried at room temperature for 2 days before drying in a vacuum oven at 80° C. for 24 hours.

### Example 3

### Membrane Preparation

Dried sulfonated polyaryletherketone (1 g) was dissolved in DMSO (4 ml), then the solution was filtered using a glass fritted filter funnel under vacuum. The film was cast from polymer solution on a glass plate using a film applicator at 60° C., then dried at room temperature for 1 day, at 80° C. under vacuum overnight. The thickness of the film was about 1 mil.

### Example 4

### Conductivity Measurements

The proton conductivity of the polymer membranes was determined by 4-electrode impedance measurements at various temperatures and relative humidities. Measurements used a Parstat impedance analyzer with PowerSine software, using a signal amplitude that ranged from 5 to 50 mV and frequencies ranging from 2 Hz to 2 MHz. The sample dimensions varied between samples, with a typical sample being 1.5 cm×2.5 cm and having a thicknesses ranging from 20 to 100 μm. Typical membranes were 25-50 μm in thickness.

The conductivity of sulfonated polyaryletherketones is shown in Table 1. Composition of the samples with respect to degree of sulfonation is displayed in Table 2. The polymers with n=30-50%, showed conductivity of above 0.2 S/cm at 80° C. with 100% relative humidity.

TABLE 1
Conductivity [S/cm]

| | | HL-II- | HL-II- | HL-II- | HL-II- | HL-II- |
|---|---|---|---|---|---|---|
| Temp, ° C. | % RH | 87 | 92 | 95 | 93 | 94 |
| 20 | 100 | 0.0373 | 0.0561 | 0.0365 | 0.0406 | 0.0417 |
| 60 | 50 | 0.0014 | 0.0027 | 0.0011 | 0.0016 | 0.0049 |
| 80 | 25 | 0.0008 | 0.0018 | 0.0005 | 0.0007 | 0.0009 |
| 80 | 50 | 0.0035 | 0.0084 | 0.0048 | 0.0058 | 0.0071 |
| 80 | 75 | 0.0140 | 0.0302 | 0.0190 | 0.0213 | 0.0297 |
| 80 | 100 | 0.1762 | 0.2116 | 0.2168 | 0.0880 | 0.2004 |
| 100 | 50 | 0.0020 | 0.0074 | 0.0024 | 0.0034 | 0.0069 |
| 100 | 75 | 0.0129 | 0.0264 | 0.0133 | 0.0145 | 0.0189 |
| 120 | 50 | 0.0014 | 0.0054 | 0.0023 | 0.0033 | 0.0034 |

TABLE 2

| Sample | n | Sulfonation, hrs |
|---|---|---|
| HL-II-87 | 30 | 6 |
| HL-II-92 | 30 | 16 |
| HL-II-95 | 40 | 6 |
| HL-II-93 | 40 | 16 |
| HL-II-94 | 50 | 6 |

Table 3 compares conductivity of SPEEK HL-1′-92 with Nafion 117 at 80° C. The conductivity of HL-II-92 was higher than Nafion 117 at 100% relative humidity, while lower than Nafion 117 at low relative humidity.

TABLE 3
Conductivity at 80° C.

| Humidity, % | HL-II-92 | Nafion 117 |
|---|---|---|
| 25 | 0.0018 | 0.003 |
| 50 | 0.0084 | 0.01 |
| 75 | 0.0302 | 0.04 |
| 100 | 0.2116 | 0.07 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A sulfonated polyaryletherketone comprising structural units of formula I 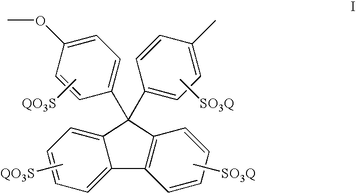
wherein Q is H, a metal cation, a non-metallic inorganic cation, an organic cation or a mixture thereof.

2. A sulfonated polyaryletherketone according to claim 1, additionally comprising structural units of formula II 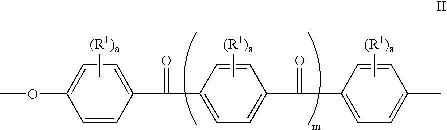
wherein R¹ is halogen, C₁-C₁₀ alkyl, C₃-C₁₂ cycloalkyl, or C₃-C₁₅ aryl;
a is an integer from 0 to 4; and
m is 0 or 1.

3. A sulfonated polyaryletherketone according to claim 3, wherein a and m are 0.

4. A sulfonated polyaryletherketone according to claim 1, additionally comprising structural units of formula III: 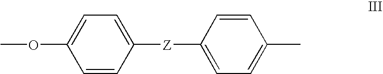
wherein Z is a direct bond or O, S, (CH₂)_{y}, (CF₂)_{y}, C(CH₃)₂, C(CF₃)₂, or a combination thereof; and
y is an integer from 1 to 5.

5. A sulfonated polyaryletherketone according to claim 4, wherein Z is C(CF₃)₂.

6. A sulfonated polyaryletherketone comprising structural units of formula IV: 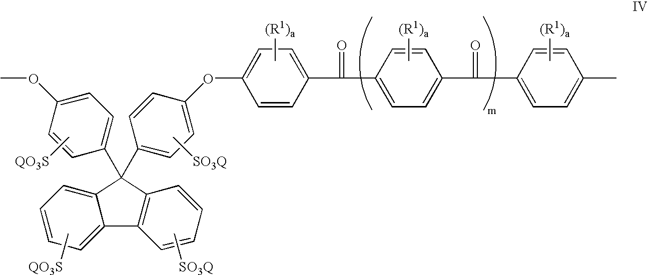
wherein R¹ is halogen, C₁-C₁₀alkyl, C₃-C₁₂ cycloalkyl, or C₃-C₁₅ aryl;
a is an integer from 0 to 4; and
m is 0 or 1.

7. A sulfonated polyaryletherketone according to claim 6, wherein a and m are 0.

8. A sulfonated polyaryletherketone according to claim 7, additionally comprising structural units of formula V: 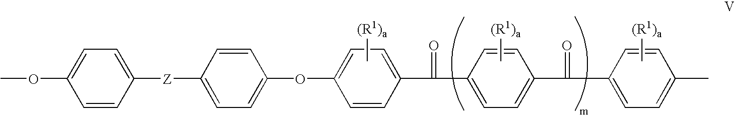
wherein R¹ is halogen, C₁-C₁₀ alkyl, C₃-C₁₂ cycloalkyl, or C₃-C₁₅ aryl;
a is an integer from 0 to 4; and
m is 0 or 1.

9. A sulfonated polyaryletherketone according to claim 8, wherein a and m are 0.

10. A sulfonated polyaryletherketone according to claim 4, wherein Z is C(CF₃)₂.

11. A sulfonated polyaryletherketone comprising structural units of formula VI and VII: 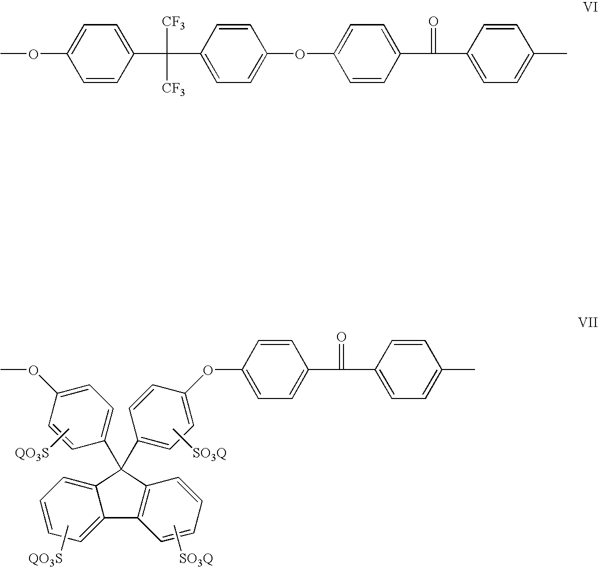
wherein Q is H, a metal cation, a non-metallic inorganic cation, an organic cation or a mixture thereof.

12. A process for controlled sulfonation of a polyaryletherketone, said process comprising
a. reacting a monomer of formula VIII with a monomer of formula IX to form a polyaryletherketone; and 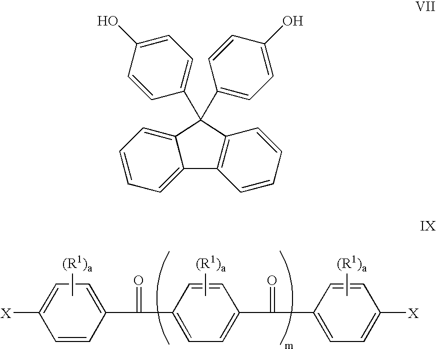
b. sulfonating the polyaryletherketone to form a sulfonated polyaryletherketone comprising structural units of formula IV 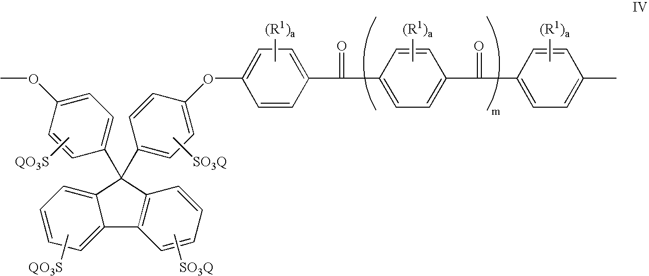
wherein R¹ is halogen, C₁-C₁₀ alkyl, C₃-C₁₂ cycloalkyl, or C₃-C₁₅ aryl;
a is an integer from 0 to 4;
Y is F, Cl, Br or a mixture thereof;
m is 0 or 1; and
Q is H, a metal cation, a non-metallic inorganic cation, an organic cation or a mixture thereof.

13. A process according to claim 12, wherein a and m are 0.

14. A process according to claim 12, additionally comprising reacting the monomer of formula VIII and monomer of formula IX with a monomer of formula X 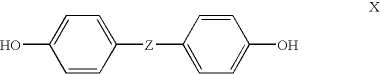
wherein Z is a direct bond or O, S, (CH₂)_{y}, (CF₂)_{y}, C(CH₃)₂, C(CF₃)₂, or a combination thereof; and
y is an integer from 1 to 5.

15. A process according to claim 14, wherein Z is C(CF₃)₂.

16. A proton exchange membrane comprising a sulfonated polyaryletherketone according to claim 1.

17. A fuel cell comprising a proton exchange membrane according to claim 16.
